(19) United States
(12) Patent Application Publication
(10) Pub. No.: US 2010/0053063 A1
(43) Pub. Date: Mar. 4, 2010

(54) Display Device and Illumination Control Method

(75) Inventor: Akio Ishii, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/422,014

(22) Filed: Apr. 10, 2009

(30) Foreign Application Priority Data
Aug. 29, 2008 (JP) 2008-222705

(51) Int. Cl. G09G 3/36

(52) U.S. Cl. 345/102

(57) ABSTRACT

According to an aspect of the present invention, there is provided a display device including: a video display unit; a housing configured to accommodate the video display unit; an illumination device provided in the housing; a power indicator provided on the housing and having a first state and a second state, the first state indicating that a power status is OFF, the second state indicating that the power status is ON; and an illumination controller configured to control the illumination device to be turned ON at a different timing shifted from a timing when the power indicator is transitioned from the first state to the second state, when the power status is transitioned from OFF to ON.

### CROSS-REFERENCE TO RELATED APPLICATIONS

This application is based upon and claims the benefit of priority from Japanese Patent Application No. 2008-222705, filed on Aug. 29, 2008, the entire contents of which are incorporated herein by reference.

### BACKGROUND

1. Field

An aspect of the present invention relates to a display device having an illumination and an illumination control method.

2. Description of the Related Art

For example, television broadcast receiving devices include a model in which an illumination device indicative of a company name etc. is provided on a periphery of a display portion for displaying a video and is turned ON as described in JP-A-2006-030313. A user can enjoy an ornament of a light through the illumination device and an appeal effect can be obtained for a purchaser.

Moreover, an electronic device such as a television broadcast receiving device usually has a power indicator indicating that a power status is ON or OFF, and a user can visually recognize a color of the power indicator, thereby recognizing the power status of the device.

JP-A-2006-030313 discloses that a lens sheet and a diffusing sheet are inserted between a light incident portion of a lower transparent component and a light source, that is, discloses a physical configuration of the illumination device.

However, how to turn ON the illumination device, for example, how to change a lighting timing or a lighting state has not been considered sufficiently. Moreover, a power illumination and an ornamental illumination could not be clearly distinguished from each other in some cases.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary view for explaining an appearance of a television broadcast receiving device according to an embodiment;

FIG. 2 is an exemplary diagram showing a main signal processing system of the television broadcast receiving device according to the embodiment;

FIG. 3 is a block diagram schematically showing an example of a configuration for controlling a lighting operation of an illumination device 119 according to the embodiment;

FIG. 4 is an exemplary flowchart showing a lighting operation of an illumination of the television broadcast receiving device according to the embodiment; and

FIG. 5 is an exemplary timing chart showing the lighting operation of the illumination of the television broadcast receiving device according to the embodiment.

### DETAILED DESCRIPTION

Various embodiments according to the present invention will be described hereinafter with reference to the accompanying drawings. In general, according to one embodiment of the present invention, there is provided a display device including: a video display unit; a housing configured to accommodate the video display unit; an illumination device provided in the housing; a power indicator provided on the housing and having a first state and a second state, the first state indicating that a power status is OFF, the second state indicating that the power status is ON; and an illumination controller configured to control the illumination device to be turned ON at a different timing shifted from a timing when the power indicator is transitioned from the first state to the second state, when the power status is transitioned from OFF to ON.

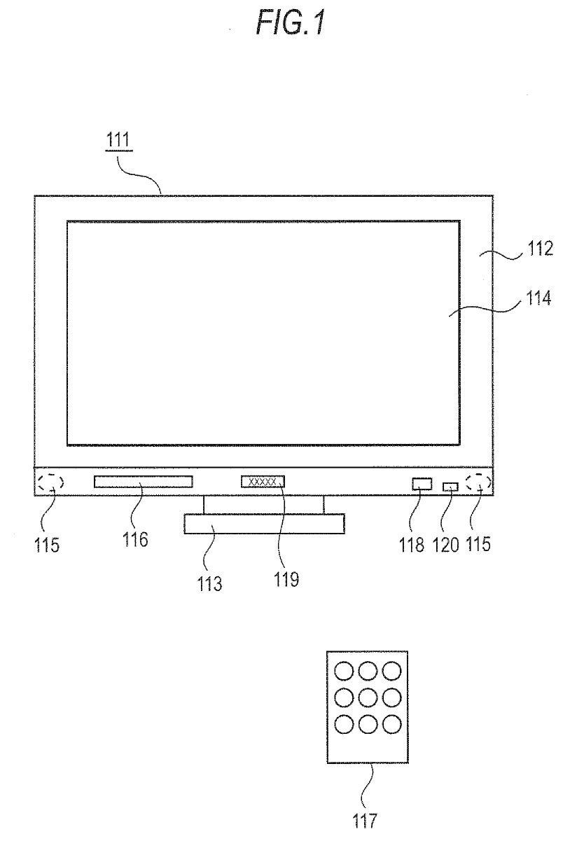

One embodiment according to the invention will be described below with reference to the drawings. FIG. 1 schematically shows an example of an appearance of a television broadcast receiving device 111 which will be described in the following embodiment.

More specifically, the television broadcast receiving device 111 mainly includes a flat housing (hereinafter referred to as a cabinet 112) and a support stand 113 for erecting and supporting the cabinet 112. The flat housing, together with the support stand 113, may be referred to as the cabinet. The cabinet 112 is provided with, for example, a video display unit 114 to be a flat panel display including a liquid crystal display panel or a plasma panel, a pair of speakers 115, an operating portion 116, and a remote control receiver 118 for receiving operating information transmitted from a remote controller 117. The operating portion 116 may be disposed on a side of the cabinet 112 in place of a front thereof.

Moreover, an illumination device 119 is provided under the video display unit 114 on an almost center of the front of the cabinet 112. The illumination device 119 is provided with a character or a symbol (a logo portion) which indicates a company name or a model name, for example, and includes an LED light as a light source, for example, as will be described below. The illumination device 119 may be configured to include various patterns other than the character or the symbol.

Furthermore, a power indicator 120 indicative of a power status of the television broadcast receiving device 111 is provided adjacently to the remote control receiver 118 in a lower right part of the cabinet 112 shown in FIG. 1. The power indicator 120 also includes an LED as a light source, for example. It is also possible to employ a configuration in which the power indicator 120 is not provided adjacently to the remote control receiver 118 and an arrangement thereof is not limited.

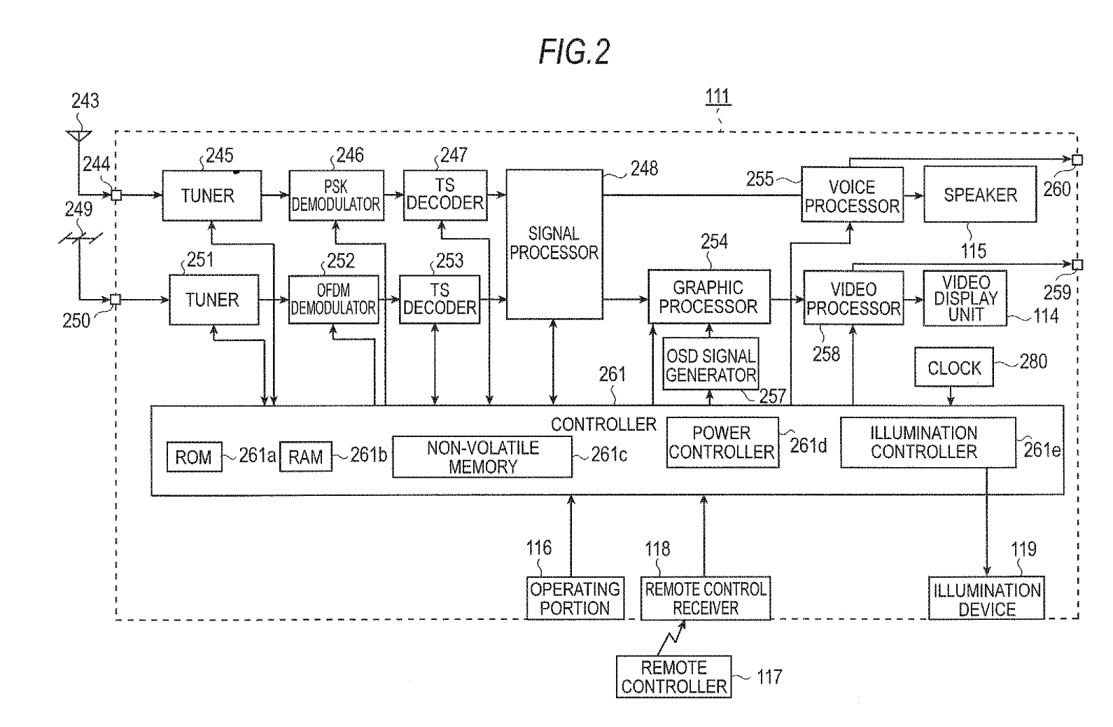

FIG. 2 shows an example of a main signal processing system of the television broadcast receiving device 111. More specifically, a satellite digital broadcasting signal received by a BS/CS digital broadcast receiving antenna 243 is supplied to a satellite digital broadcasting tuner 245 through an input terminal 244 so that a broadcasting signal for a desirable channel is selected.

Then, the broadcasting signal selected by the tuner 245 is supplied to a Phase Shift Keying (PSK) demodulator 246 and then a Transport Stream (TS) is demodulated. The TS is supplied to a TS decoder 247 and is thus decoded into such as digital video, voice and data signals, and they are thereafter output to a signal processor 248.

Moreover, a digital terrestrial television broadcasting signal received through a terrestrial broadcast receiving antenna 249 is supplied to a digital terrestrial broadcasting tuner 251 through an input terminal 250 so that a broadcasting signal for a desirable channel is selected.

Then, the broadcasting signal selected by the tuner 251 is supplied to an Orthogonal Frequency Division Multiplexing (OFDM) demodulator 252 so that the TS is demodulated. The TS is supplied to a TS decoder 253 and is thus decoded into such as digital video, voice and data signals, and they are thereafter output to the signal processor 248.

An analog terrestrial television broadcasting signal received through the terrestrial broadcast receiving antenna 249 is supplied to an analog terrestrial broadcasting tuner (not shown) through the input terminal 250 so that a broadcasting signal for a desirable channel is selected. The broadcasting signal selected by the tuner is then supplied to an analog demodulator (not shown) and is thus demodulated into analog video and voice signals, and they are thereafter output to the signal processor 248.

Subsequently, the signal processor 248 selectively carries out a digital signal processing over the digital video and voice signals supplied from the TS decoder 247 and the TS decoder 253 respectively in television viewing, and outputs them to a graphic processor 254 and a voice processor 255.

A controller 261 inputs various data for acquiring a program, electronic program guide (EPG) information, program attribute information (a program genre) and caption information (service information, SI or PSI) from the signal processor 248 and the TS decoders 247 and 253. The controller 261 carries out an image generation processing for displaying the EPG and the caption from the input information and outputs the image information thus generated to the graphic processor 254.

The graphic processor 254 has a function for superposing an On Screen Display (OSD) signal generated by an OSD signal generator 257 on the digital video signal supplied from the signal processor 248 and outputting the superposed signal. Moreover, the graphic processor 254 can selectively output the video signal output from the signal processor 248 and the OSD signal output from the OSD signal generator 257 and can send both of the outputs in combination in order to configure a half of a screen, respectively.

The digital video signal output from the graphic processor 254 is supplied to a video processor 258. The video processor 258 converts the input digital video signal into an analog video signal in a format which can be displayed through the video display unit 114 and then outputs the analog video signal to the video display unit 114 to display a video, and furthermore, leads the analog video signal to an outside through an output terminal 259.

Moreover, the voice processor 255 converts the input digital voice signal into an analog voice signal in a format which can be reproduced through the speaker 115 and then outputs the analog voice signal to the speaker 115 to reproduce a voice, and furthermore, leads the analog voice signal to the outside through an output terminal 260. In addition, the television broadcast receiving device 111 includes a clock 280 for measuring a current time.

In the television broadcast receiving device 111, all of operations including the various receiving operations are chiefly controlled by the controller 261. The controller 261 includes a Central Processing Unit (CPU) and receives operating information from the operating portion 116 or receives operating information received from the remote controller 117 through the remote control receiver 118 and controls the respective portions to reflect the operating contents.

In this case, the controller 261 mainly utilizes a Read Only Memory (ROM) 261a for storing a control program to be performed by the CPU, a Random Access Memory (RAM) 261b for providing a work area to the CPU, and a nonvolatile memory 261c for storing an on-timer time, various set information and control information.

Moreover, the controller 261 includes a power controller 261d. The power controller 261d controls the power status of the television broadcast receiving device 111 and controls an ON/OFF operation of the power indicator 120 in response to the operations at the user operating portion 116 and the remote controller 117. More specifically, the ON/OFF operation of the power indicator 120 is controlled as will be described below. In other words, when a main power button provided in the operating portion 116 is pressed, a state of power turns to be “ON” (ON state) and the power indicator 120 is turned ON to take on a green color, for example. Even if the state turns to be ON, a starting time is required. For this reason, a video is not displayed instantly. More specifically, a video is displayed on the video display unit 114 or a voice is output from the speaker 115 after a passage of the starting time (for example, approximately five seconds) for activating a panel power source or various signal processing circuits. When the main power button is pressed again, the power status turns to be “OFF” state and the video display and the voice output are stopped, and furthermore, the power indicator 120 is turned OFF.

When a power button of the remote controller 117 is pressed in the power “ON” state, moreover, the video display and the voice output are stopped and the power indicator 120 is changed from the green color to a color such as a red color or a yellow color to bring a so-called standby state in which only a part of internal circuits are operated. Furthermore, when the power button of the remote controller 117 is pressed in the standby state, the power indicator 120 is changed from the color such as the red color or the yellow color to the green color and a video is displayed on the video display unit 114 and a voice is output. In the embodiment, a state in which the video or the voice is output is set to be a power ON state (an operating state) and a state in which neither the video nor the voice is output is set to be a power OFF state. It is assumed that the power OFF state includes the standby state (in the embodiment, a state in which the power source of the television broadcast receiving device 111 is turned OFF through the power button of the remote controller 117) in addition to a state in which the main power source is not turned ON. Thus, the power indicator 120 has a state indicating that the power status is OFF (in the example, OFF, red and yellow) and a state indicating that the power status is ON (in the example, green).

Moreover, the controller 261 includes an illumination controller 261e. The illumination controller 261e controls the ON/OFF operation of the illumination device 119.

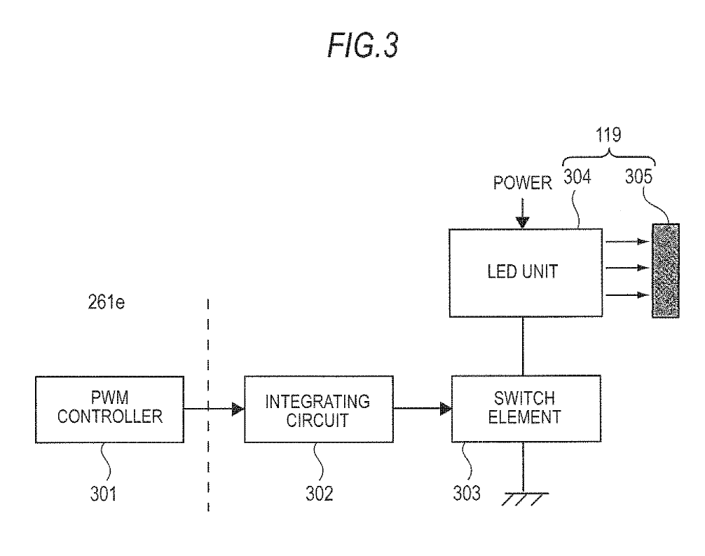

FIG. 3 is a block diagram schematically showing an example of a configuration for controlling the lighting operation of the illumination device 119 through the illumination controller 261e.

The illumination controller 261e is configured to include a Pulse Width Modulation (PWM) controller 301. The PWM controller 301 generates a PWM control signal and outputs the PWM control signal to an integrating circuit 302 in a subsequent stage with a timing shifted by a given time after the power status is changed from OFF to ON (after the state turns to be ON state). The given time is previously recorded in a recording medium such as the nonvolatile memory 261c, and an oscillating circuit (not shown) carries out counting corresponding to that time, for example. After the counting for the time through the oscillating circuit is ended, the PWM control signal is output from the PWM controller 301. In the television broadcast receiving device 111, the power status is turned ON and various signal processing circuits and the panel power source are activated so that the video and the voice are output. However, the starting time is required as described above before the video is displayed immediately after the power status turns to be ON. If the starting time is five seconds, for example, the PWM control signal is output after counting for five seconds through the oscillating circuit.

The integrating circuit 302 is disposed as a delay circuit and integrates the input PWM control signal with a time, and outputs the PWM control signal thus integrated to a switch element 303 in a subsequent stage. As the integrating circuit 302, an RC circuit is used, for example.

The switch element 303 carries out a switching operation in response to the input PWM control signal, thereby controlling a power supply to an LED unit 304 and a stop of the power supply. For the switch element 303, it is possible to use a transistor element. The switching operation is carried out in response to the PWM control signal input through the integrating circuit 302. The illumination controller 261e may also include the integrating circuit 302 and the switch element 303.

The LED unit 304 includes some LED elements and is turned ON by a power supplied. A logo portion 305 is configured by a transparent acrylic resin material and has a character, a symbol and a pattern indicating a company name and a model name which are printed thereon.

Moreover, the illumination controller 261e carries out a control for always turning OFF the lighting operation of the illumination device 119 in response to a user operation. More specifically, when a dark video such as a movie is to be viewed and the user does not want the illumination device 119 to be ON, it is possible to select OFF setting of the illumination device 119 by displaying a menu screen on the video display unit 114 through the remote controller 117 and operating the menu screen. In the embodiment, thus, it is possible to select, based on the user operation, an ON mode in which the illumination device 119 is turned ON in the power ON state and an OFF mode in which the illumination device 119 is not turned ON in the power ON state. In the ON mode, it is possible to further provide a mode in which the illumination device 119 is turned ON in a lower luminance than usual.

Although the power indicator 120 is continuously maintained to be ON with a change in a lighting color to the red color, for example, in the standby state of the television broadcast receiving device 111 in the embodiment, moreover, the illumination device 119 is turned OFF.

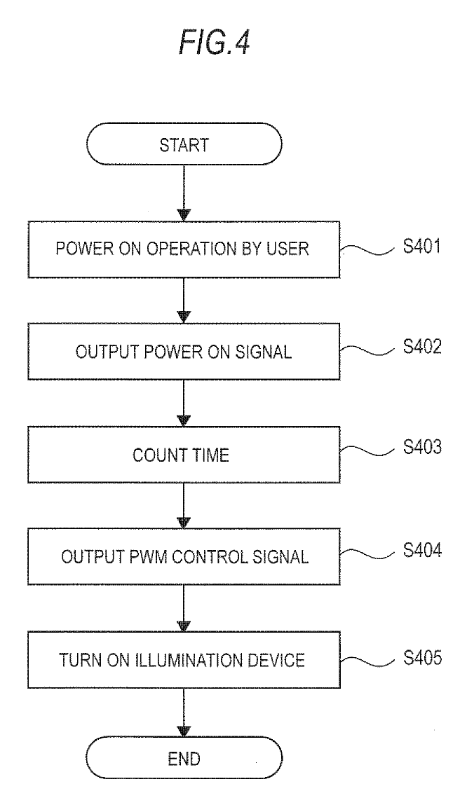

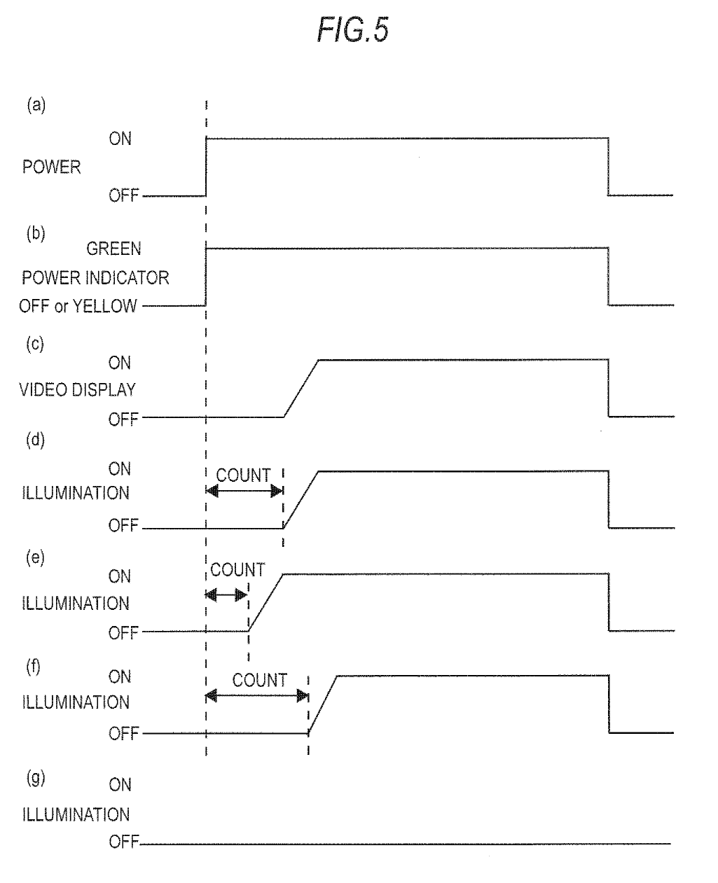

Next, the lighting operation of the illumination device 119 of the television broadcast receiving device 111 according to the embodiment will be described with reference to a flowchart of FIG. 4 and a timing chart of FIG. 5.

First of all, a power ON operation is carried out at the user operating portion 116 or the remote controller 117 (for example, the main power button provided in the operating portion 116 is pressed or the power button of the remote controller 117 is pressed in the standby state) (Step 401).

Consequently, the controller 261 outputs a control signal (a power ON signal) for bringing the television broadcast receiving device 111 into the ON state to a liquid crystal panel and various signal processing circuits (Step 402). When the power ON signal is supplied, the liquid crystal panel and the signal processing circuits start operations and a processing for outputting a video and a voice is performed. Simultaneously with the output of the power ON signal, the television broadcast receiving device 111 turns to be the ON state and the color of the power indicator 120 is changed into the green color, for example (see FIG. 5, sections (a) and (b)). Although the power indicator 120 is turned ON, the illumination device 119 has not been turned ON at this time.

Next, an oscillating circuit (not shown) counts a time after the power ON signal is output (Step 403). When the counting corresponding to the time stored in the nonvolatile memory 261c is ended, then, the PWM controller 301 outputs the PWM control signal to the integrating circuit 302 in the subsequent stage (Step 404). In other words, a timing is shifted by a preset time after the power source turns to be the ON state and the PWM control signal is supplied to the integrating circuit 302 in the subsequent stage. Consequently, the lighting timings of the power indicator 120 and the illumination device 119 are shifted from each other.

Subsequently, the switch element 303 is gradually brought into the ON state with a delay of the PWM control signal through the integrating circuit 302. Therefore, a current flowing to the LED element in the LED unit 304 is slowly increased and the LED element is correspondingly brightened slowly. Then, a certain brightness is obtained. Thereafter, the logo portion 305 is illuminated by the light of the LED element and is thus brightened slowly (Step 405). Consequently, it is possible to obtain an intended ornamental effect.

When there is employed a configuration in which the starting time required for displaying a video immediately after the television broadcast receiving device 111 turns into the ON state is five seconds, for example, and the PWM control signal is output after counting an equal time (five seconds) to the starting time, the illumination device 119 is turned ON almost simultaneously with the display of the video. Thus, the illumination device 119 is turned ON almost simultaneously with the display of the video or corresponding to the fact that the video in a dark condition is brightened slowly (FIG. 5, sections (c) and (d)). By turning ON the power indicator and the illumination in different timings, accordingly, it is possible to clearly distinguish the power indicator intended for indicating the power status from the illumination intended for the ornamental effect. Moreover, the user can be prevented from having an uncomfortable feeling that the illumination device 119 is ON though the video is not displayed. FIG. 5, section (c) shows a situation in which the display of the video makes a transition in such a manner that a dark video is gradually brightened after a passage of the starting time. Moreover, FIG. 5, sections (d) to (f) show a situation in which the illumination is turned ON to be gradually brightened after a passage of a time.

It is also possible to employ a configuration in which the timing is not taken with the time by using the oscillating circuit but the illumination controller 261e controls the output of the PWM control signal and the lighting operation of the illumination device 119 is controlled when a back light is turned ON and a video signal is supplied to a panel in case of a liquid crystal TV, for example. More specifically, it is also possible to employ a configuration in which the controller 261 detects that the video is displayed and the lighting operation of the illumination device 119 is controlled based on the detection. With the configuration, the illumination device 119 is started to be turned ON almost simultaneously with the display of the video. Thus, it is possible to propose various manners for the control of the lighting operation of the illumination device 119, for example, a manner for using the oscillating circuit or a manner for using the detection of the display of the video.

A luminance level of the illumination device 119 may be set and changed according to a user's preference over the operating menu screen.

The illumination device 119 starts the lighting operation before the video is displayed and the illumination device 119 is turned ON before the video is displayed when there is employed a configuration in which the starting time is five seconds, for example, and the PWM control signal is output after counting for a shorter time (for example, four seconds) than the starting time, moreover. Thus, it is also possible to employ a configuration in which the illumination device 119 is started to be turned ON before the video is displayed (see FIG. 5, sections (c) and (e)). With the configuration, the illumination is turned ON before the video is displayed but starts the lighting operation with a passage of a period after it is brought into the ON state. Therefore, it is possible to reduce an uncomfortable feeling that the illumination is turned ON though the video is not displayed.

When there is employed a configuration in which the starting time is five seconds, for example, and the PWM control signal is output after counting for a longer time (for example, six seconds) than the starting time, furthermore, the illumination device 119 starts the lighting operation after the video is displayed. Thus, it is also possible to employ a configuration in which the illumination device 119 is started to be turned ON after the video is displayed (see FIG. 5, sections (c) and (f)). Accordingly, it is possible to prevent the user from having an uncomfortable feeling that the illumination is turned ON though the video is not displayed.

Moreover, when the illumination device 119 is set to be OFF by the user operation, the illumination device 119 is always turned OFF irrespective of the power status (see FIG. 5, section (g)).

As described above, in the embodiment, the lighting timings of the power indicator and the illumination are shifted from each other. Therefore, the illumination is clearly distinguished from the power indicator indicative of the power status so that the user can be prevented from having the uncomfortable feeling that the illumination is turned ON though the video is not displayed. Moreover, by providing the OFF setting of the illumination device 119, the user can easily set the illumination to be OFF even if he (she) does not desire the lighting operation of the illumination when a dark scene of a movie is to be viewed at home. Since the user can be prevented from feeling that the illumination device 119 is an obstacle to the view or is dazzling, he (she) can concentrate on an appreciation of a video.

In the embodiment, moreover, there is employed the configuration in which the illumination is gradually brightened from a dark state. Therefore, it is possible to prevent a viewer from having an uncomfortable feeling without disturbing a feeling that the video is displayed.

The invention is not exactly restricted to the embodiment but the components can be changed to be concrete without departing from the scope in an implementing stage. By a proper combination of the components disclosed in the embodiment, moreover, it is possible to form various inventions. For example, in the embodiment, the illumination device 119 is gradually brightened in the lighting operation by the configurations of the PWM controller 301 and the integrating circuit 302. However, it is also possible to employ a configuration in which a rising speed can be increased without providing the integrating circuit 302 and the illumination device 119 can be quickly brightened with a passage of a time in the power ON state. Although the brightness is constant after the lighting operation of the illumination device 119 in the embodiment, moreover, it is also possible to dynamically change the brightness of the illumination device 119 in the power ON state. Moreover, it is possible to change the lighting colors of the illumination and the power indicator depending on a light emitting element to be used.

Although the illumination device 119 is OFF in the standby state in the embodiment, moreover, the illumination device 119 may be turned ON in the standby state or a mode having a lower luminance than usual may be provided. Moreover, it is also possible to employ a configuration in which the illumination device 119 is caused to flash in the power ON state.

1-7. (canceled)

8. A display device comprising:
a video display unit;
an illumination device provided in a housing that accommodates the video display unit;
a power indicator provided in the housing and having a first state indicating that a power status is OFF and a second state indicating that the power status is ON; and
an illumination controller configured to control lighting of the illumination device, wherein
the illumination controller is configured to control the illumination device to be turned ON at a different timing shifted from a timing when the power indicator is transitioned from the first state to the second state, when the power status is turned from OFF to ON.

9. The display device of claim 8, wherein the illumination controller is configured to control the illumination device to be gradually brightened when the illumination device is turned ON.

10. The display device of claim 8, wherein the illumination controller is configured to control the illumination device to start lighting after the power indicator makes a transition to the second state and before a video is displayed on the video display unit.

11. The display device of claim 8, wherein the illumination controller is configured to control the illumination device to start lighting simultaneously with a display of a video on the video display unit and after the power indicator makes a transition to the second state.

12. The display device of claim 8, wherein the illumination controller is configured to control the illumination device to start lighting after the power indicator makes a transition to the second state and after a video is displayed on the video display unit.

13. The display device of claim 8, further comprising a selector that has:
a first operating mode in which the illumination device is turned ON when the power status is ON; and
a second operating mode in which the illumination device is not turned ON when the power status is ON, and
that selects one of the first operating mode and the second operating mode in response to a user's operation.

14. An illumination control method of a device including an illumination device and a power indicator indicative of a power status, comprising:
turning ON the power indicator to indicate that the power status is ON when the power status turns ON in response to a user's operation; and
turning ON the illumination device at a different timing shifted from a timing when the power indicator turns ON.
